(19) United States
(12) Patent Application Publication
(10) Pub. No.: US 2009/0084219 A1
(43) Pub. Date: Apr. 2, 2009

(54) Robotic manipulator

(75) Inventor: Mark E. Rosheim, Minneapolis, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Ross-Hime Designs, Inc., Minneapolis, MN (US)

(21) Appl. No.: 12/283,236

(22) Filed: Sep. 10, 2008

Related U.S. Application Data
(60) Provisional application No. 60/993,128, filed on Sep. 10, 2007.

(51) Int. Cl. G01C 19/08

(52) U.S. Cl. 74/5 R

(57) ABSTRACT

A controlled relative motion system that permits a controlled motion member, joined to a base member, to selectively move with respect to said base member having a base support, an output structure, and a plurality of securing links including a fixed length securing link that is rotatably connected at one end thereof to the base support and rotatably connected at an opposite end thereof to the output structure. Further included is a variable length securing link that is rotatably connected at one end thereof to the base support and rotatably connected at an opposite end thereof to the output structure and having a force distributor therewith that can be directed to vary a separation distance between said ends thereof by a force imparting member capable of directing the force distributor to vary the separation distance between the variable length securing link ends.

### CROSS-REFERENCE TO RELATED APPLICATION

This application claims the benefit of Provisional Patent Application No. 60/993,128 filed Sep. 10, 2007 for ROBOTIC MANIPULATOR.

### BACKGROUND

Increasing use of precision directional sensors has added to the need for mechanical manipulators that can point objects, or workpieces, mounted thereon, such as those sensors, accurately and repeatedly anywhere in a desired workspace. Singularities in the dynamics of such manipulators, or loss of a degree-of-freedom in the workspace, due both to conditions in the physical structure or in control software used in the control system provided therefor, often impede the performance of mechanical manipulators in reaching these goals.

Many uses of these mechanical manipulators require a highly precise but limited range of motion for the manipulator in providing various desired pointings of objects mounted thereon. One such manipulator that has been used for these purposes is provided by gimbals supporting an object for pointing such as a sensor. In the past, such pointing gimbals have had a gimbal ring arrangement operated by a pair of drive motors. Their use requires providing therewith either flexible wiring or slip-rings, or both, to supply electrical power to the mounted object, and to provide position and rate information to at least one of the drive motors. These slip-rings, or other forms of supplying electrical power and communicating information through or around objects rotating relative to each other, often result in reliability problems due to mechanical wear, aging through corrosion, and other environmental factors.

In many instances, and in particular, in airborne systems such as missiles, it is very advantageous for manipulators, being used for pointing sensors therein in desired directions, to be very compact. Not only do such manipulators need to be compact in mechanical extent but also must manipulate the sensor mounted thereon in a very compact workspace. The sensors themselves may take a relatively large fraction of the work envelope within which they are manipulated. This necessitates a robotic manipulator that has at least portions thereof with a relatively thin cross-section that permits operation in a confined space while at the same time manipulating a relatively bulky sensor. One reason for this limiting of the sensor minimum size becoming critical is due to the geometry required for the missile nose cone that is necessary for it to meet its aerodynamic performance specifications. The nose cone, for example, may incorporate a hemispherical transparent lens defining the workspace that, as indicated above, requires the motion of the sensor to track the geometry of the interior surface of that lens at a constant small separation distance such that the sensor pointing, or sensing, axis is maintained in directions normal to that surface.

Another performance requirement is that an object that is mounted on the manipulator, such as a sensor, is to be isolated from shock and vibration. Such mechanical disturbances are always present in uses of these manipulators such as when a missile, in which a sensor is mounted on one of those manipulators, is being handled, carried on a moving platform, or propelled in flight. Elaborate and costly means have been designed for gimbal mounted sensors to isolate them from shock and vibration transmitted thereto by the gimbals. However, this adds to the cost and complexity of the device. Thus, there is a desire for an improved pointing mechanical manipulator especially for use requiring precise direction positioning.

### SUMMARY

The present invention provides a controlled relative motion system that permits a controlled motion member, joined to a base member, to selectively move with respect to said base member that comprises a base support, an output structure, and a plurality of securing links each rotatably connected at one end thereof to the base support and rotatably connected at an opposite end thereof to the output structure, including a fixed length securing link that is rotatably connected at one end thereof to the base support and rotatably connected at an opposite end thereof to the output structure. Further included in this plurality is a variable length securing link that is rotatably connected at one end thereof to the base support and rotatably connected at an opposite end thereof to the output structure and having a force distributor therewith that can be directed to vary a separation distance between said ends thereof. In addition, there is a force imparting member coupled to the variable length securing link force distributor capable of directing the force distributor to vary the separation distance between the variable length securing link ends.

### BRIEF DESCRIPTION OF THE DRAWINGS

FIG. 1 is a perspective view of a mechanical manipulator embodying the present invention,

FIG. 2 is another perspective view of the manipulator shown in FIG. 1,

FIG. 3 is another perspective view of the manipulator shown in FIG. 1,

FIG. 4 is a top view of the manipulator shown in FIG. 1,

FIG. 5 is a bottom view of the manipulator shown in FIG. 1,

FIG. 6 is a perspective view of a portion of the manipulator shown in FIG. 1,

FIG. 7 is another perspective view of a portion of the manipulator shown in FIG. 1,

FIG. 8 is a side cross section view of the manipulator shown in FIG. 1,

FIG. 9 is a perspective view of a portion of the manipulator shown in FIG. 1,

FIG. 10 is a top cross section view of the portion of the manipulator shown in FIG. 9,

FIG. 11 a side cross section view of the portion of the manipulator shown in FIG. 9,

FIG. 12 is a side cross section view of the portion of the manipulator shown in FIG. 9,

FIG. 13 is a perspective view of part of the portion of the manipulator shown in FIG. 9, and

FIG. 14 is an alternative embodiment of the portion of the manipulator shown in FIG. 9.

### DETAILED DESCRIPTION

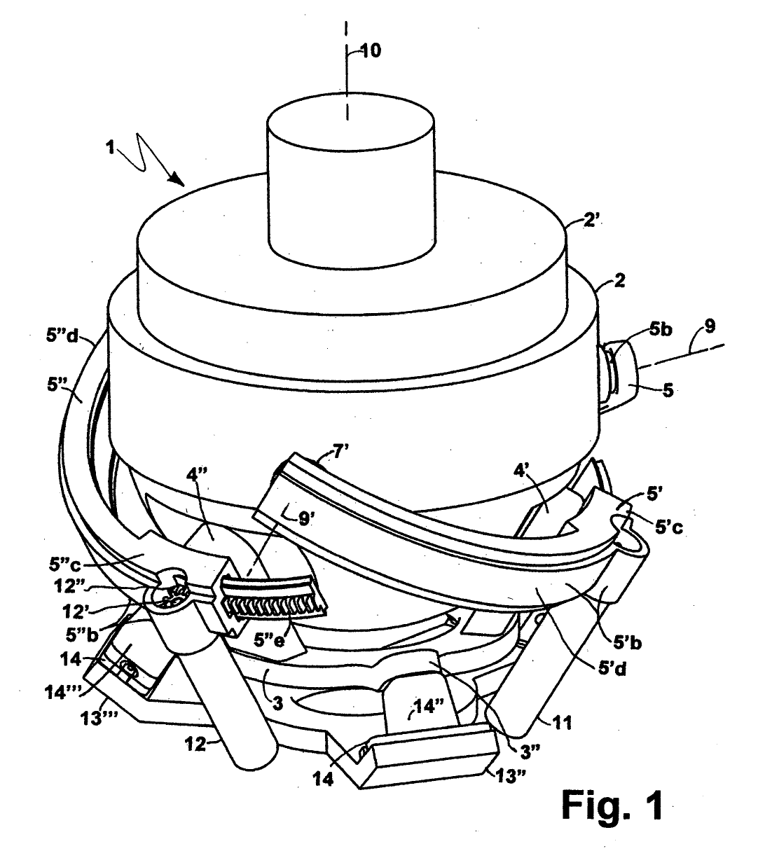

The object positioning arrangement shown in the perspective view in FIG. 1 allows an object or workpiece to be rotated to various directional pointings by a manipulator, 1, about a single center point of rotation. This point is coincident with an approximate center of an output structure, 2, and perhaps also of a workpiece, 2′, mounted thereon if mounted to also be within the open interior of that output structure. Thus, workpiece 2′, depending on its size, may be mounted above, across from, or even below the center point of rotation in the open interior of output structure 2. Alternatively, output structure 2 and workpiece 2′ may be to some extent structurally integrated through having some shared structural members. The center point of rotation is the intersection of three axes about which supporting and manipulating linking arrangements are rotatably connected to output structure 2.

This configuration is particularly advantageous when manipulating workpiece object 2′, such as a sensor, which, when placed in motion by manipulator 1, must follow closely the interior surface of a lens or radome while requiring minimum lengths of wire, tubing, or fiber optic harnesses for conveying power and signals to or from that workpiece object, or both. Also, the workpiece object, again such as a sensor, may need to undergo those motions in a very compact workspace without mechanically interfering with its housing or other structures positioned in the vicinity thereof.

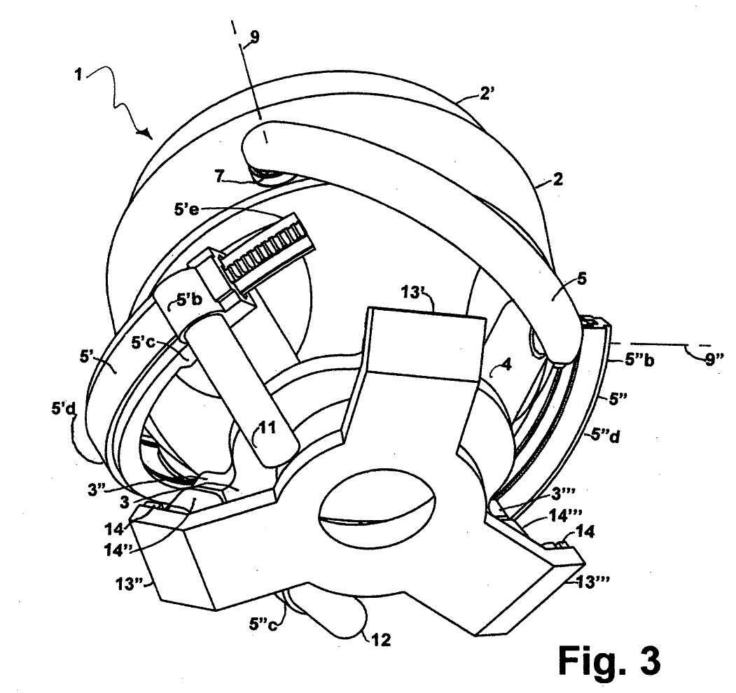

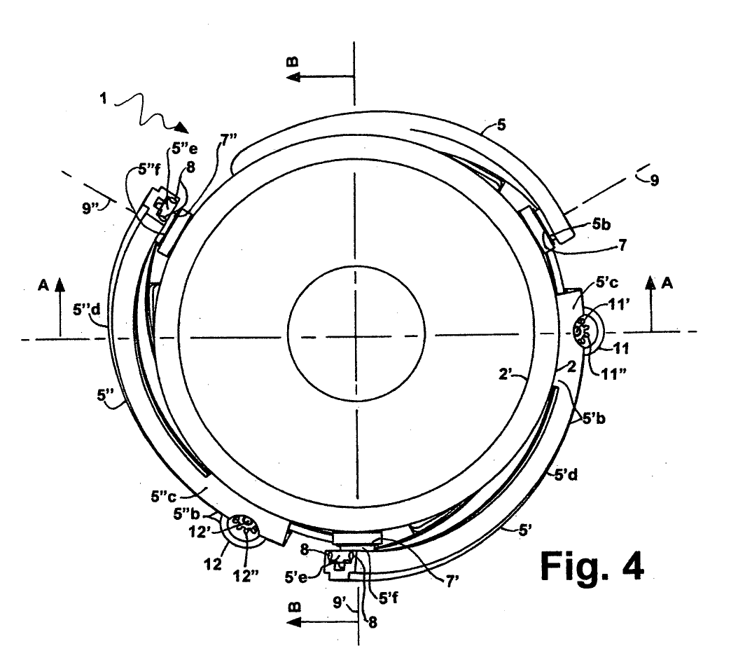

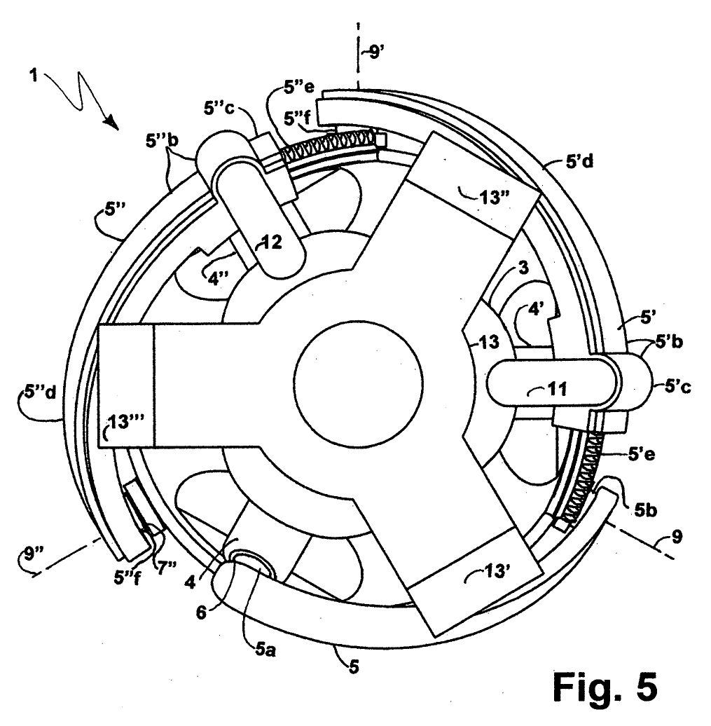

As shown in the perspective views of manipulator 1 provided in FIGS. 1, 2 and 3 from differing vantage points, and in the top view thereof in FIG. 4, and the bottom view thereof in FIG. 5, an interior base, 3, is primarily formed of a circular ring with a circular center opening. Three lugs, 3′, 3″ and 3′″, each with a center opening therein and each symmetrically spaced about the periphery of the primary ring in base 3, are also there each inclined upward and outward from the ring outer edge at an angle of approximately 30° with respect to the plane of that primary ring, these lugs to be further described below. Interior base 3 has affixed thereto, at an upper ring surface and at symmetrically spaced locations thereon near the ring outer periphery, three support standards, 4, 4′ and 4″. Each extends upward and outward from the interior base primary ring at an angle of approximately 30° with respect to the plane of that primary ring, and has a circular opening at the top thereof to accommodate therein a circular bearing arrangement or bushing.

As indicated above, there are three linking arrangements that are each rotatably connected at an end thereof to output structure 2, and they are also rotatably connected at the other end thereof to a corresponding one of support standards 4, 4′ and 4″. The first of these linking structures is a fixed length linking structure, 5, extending along a spatial circular arc path (not a required shape) that is rotatably connected at one end thereof to support standard 4. The other two linking structures are compound variable length linking structures, the first of these, 5′, also extending along a spatial circular arc path (not a required shape) to be rotatably connected at one end thereof to support standard 4′ and the second, 5″, again extending along a spatial circular arc path (not a required shape) to be rotatably connected at one end thereof to support standard 4″.

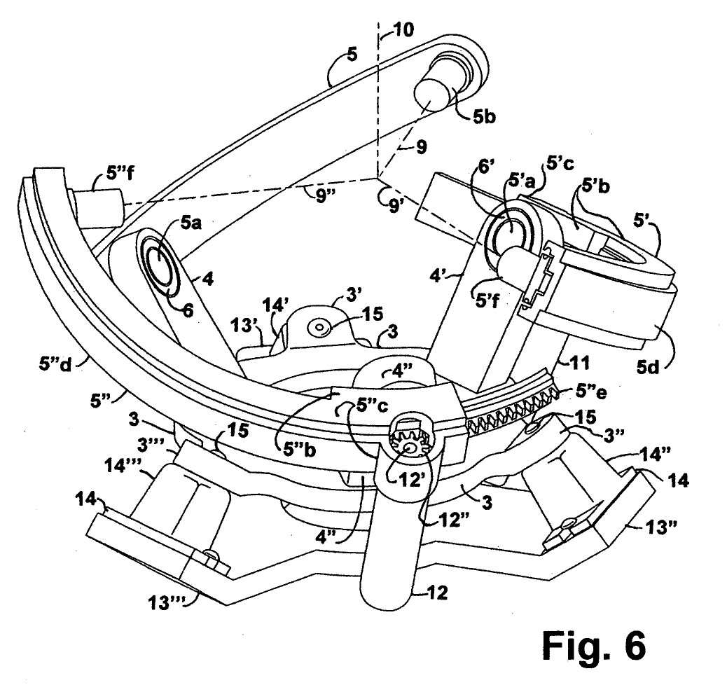

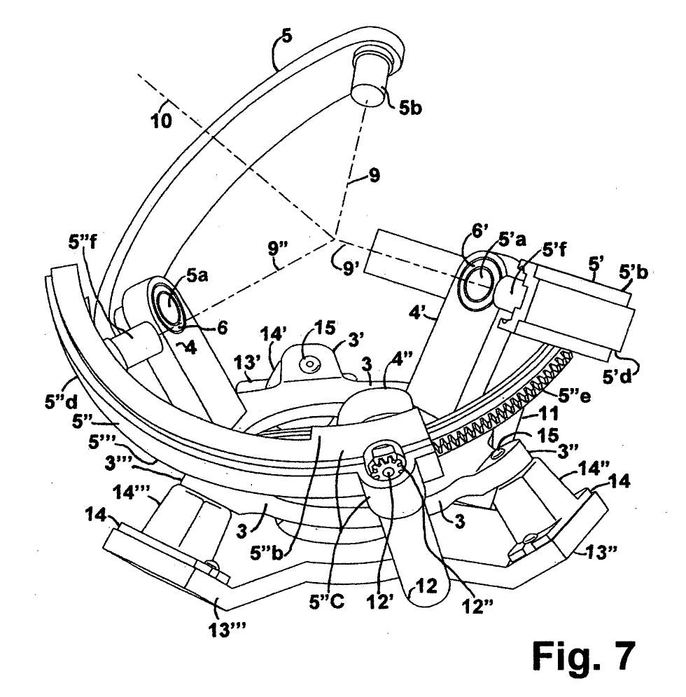

The rotatable connection between linking structure 5 and support standard 4 is provided by a circular pin, 5a, shown in the perspective views of FIGS. 6 and 7, with a collar at its fixedly supported root, this pin extending from the interior of linking structure 5 at the base connected end thereof toward output structure 2. Pin 5a is positioned in an assembly in the circular opening of the inner race of a bearing, 6, with its collar against that race, this bearing having its outer race fixed in the circular opening at the top of support standard 4 as seen in the perspective views in FIGS. 6 and 7 of manipulator 1 each having the linking structures in a corresponding one of two different positions with output structure 2 and workpiece 2′ removed therefrom.

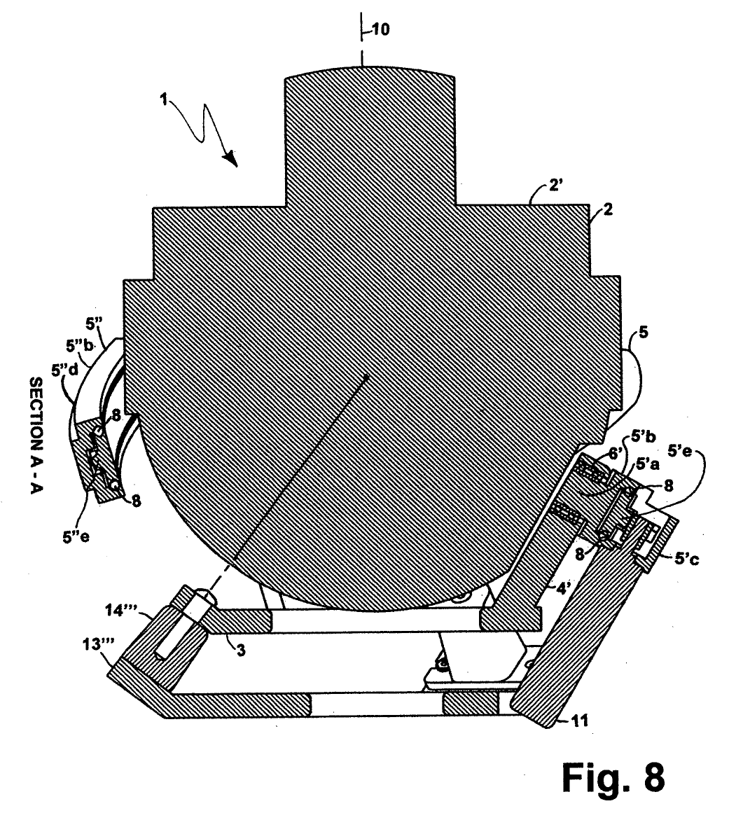

Turning to the compound linking structures, also seen in those figures, compound linking structure 5′ has a circular pin, 5′a, with a collar at its fixedly supported root, extending toward output structure 2 from an outer track member, 5′b, at an inner wall of an enclosure, 5′c, therein at the base connection end of that track member which enclosure is formed about an open rotary force assertion space. Enclosure 5′c of outer track member 5′b has extending from it, along the spatial circular arc path followed by compound linking structure 5′, a partially enclosed track structure, 5′d, that is enclosed about an interior track space except for a slot facing toward the interior of compound linking structure 5′. The rotatable connection between linking structure 5′ and support standard 4′ is provided by pin 5′a extending in assembly into the circular opening in the inner race of a bearing, 6′, with its collar against that race, this bearing having its outer race fixed in the circular opening at the top of support standard 4′ as seen in FIGS. 6 and 7. A cross section view of this rotatable connection of linking structure 5′ and support standard 4′ is shown in FIG. 8 where a side cross section view is presented corresponding to a section line, A-A, indicated in the top view of FIG. 4.

Similarly, for the rotatable connection linking structure 5″ to support standard 4″, that linking structure has a circular pin, 5″a, with a collar at its fixedly supported root, extending toward output structure 2 from an outer track member, 5″b, at an inner wall of an enclosure, 5″c, therein at the base connection end of that track member which enclosure is formed about an open rotary force assertion space. Enclosure 5″c of outer track member 5″b has extending from it, along the spatial circular arc path followed by compound linking structure 5″, a partially enclosed track structure, 5″d, that is enclosed about an interior track space at an outer side joining enclosing end and an inner except for a slot therein facing toward the interior of compound linking structure 5″. The rotatable connection between linking structure 5″ and support standard 4″ is provided by pin 5″a extending in assembly into the circular opening in the inner race of a bearing, 6″, with its collar against that race, this bearing having its outer race fixed in the circular opening at the top of support standard 4″. Although not seen in FIGS. 6 and 7, the foregoing rotatable connection between linking structure 5″ and support standard 4″ is like that of the rotatable connection between linking structure 5′ and support standard 4′.

At the other end of fixed length linking structure 5, there is another rotatable connection provided between that end of linking structure 5 and output structure 2. This rotatable connection is provided by another circular pin, 5b, with a collar at its fixedly supported root, extending toward output structure 2 from the interior of linking structure 5 at the output structure connected end thereof. Pin 5b is positioned in assembly in a circular opening in the inner race of a bearing, 7, with its collar against that race, this bearing having its outer race fixed in a circular hole in the side of output structure 2 (with this structure having an outward protruding extension collar there to effectively deepen that hole) as seen to at least some extent in FIGS. 1, 2, 3, 4 and 5.

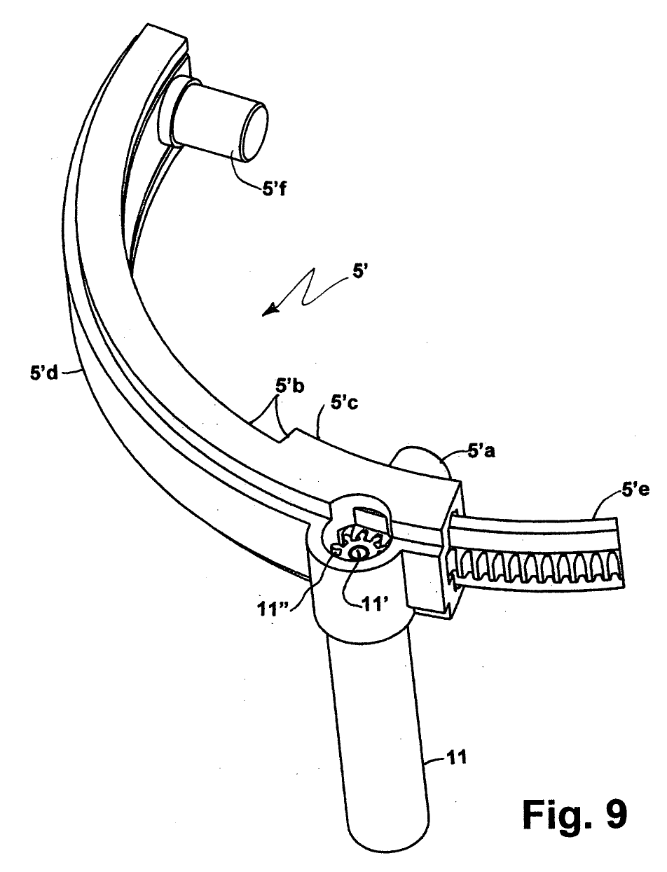

The ends of the compound linking structures opposite those ends thereof described above are also rotatably connected but to output structure 2. Thus, compound linking structure 5′, shown in a perspective view in FIG. 9, further has a rack strip member, 5′e, variably positionable in the rotary force assertion space and interior track space of outer track member 5′b. Rack strip member 5′e has an outer major surface on one side thereof and an inner major surface on the opposite side thereof along the length of that member with each major surface extending between two grooved edges on opposite sides of these major surfaces, and that are grooved by each edge having a recessed channel therein along the length of that member. The outer major surface of rack strip member 5′e has gear teeth symmetrically positioned between the grooved edges thereof along the length of that member, and the inner major surface is flat between the grooved edges along the member length except for having affixed thereat a circular pin, 5′f, with a collar at its fixedly supported root, extending toward output structure 2 through the slot in outer track member 5′b.

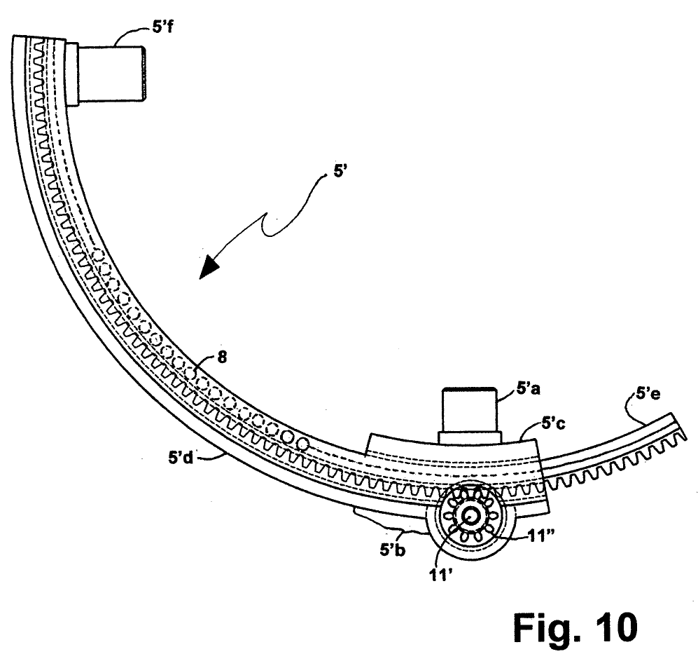

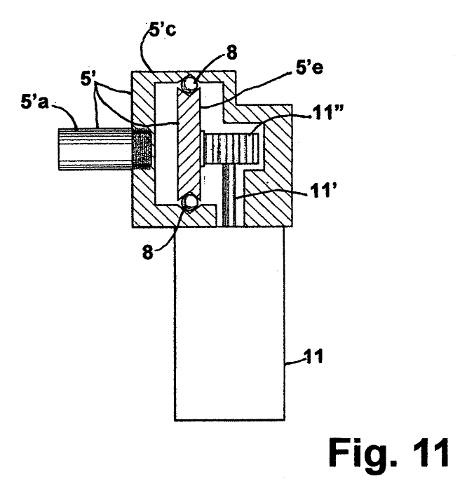

A plurality of ball bearings, 8, are trapped in assembly in the channels of the grooved edges of rack strip member 5′e by the interior sides of enclosure 5′c, and by partially enclosed track structure 5′d of outer track member 5′b with its enclosing ends. This enclosure and structure both also have channels therein across from those of the grooved edges to aid in trapping ball bearings 8. Ball bearings 8 are otherwise free to rotate in those channels to thereby enable rack strip member 5′e to be moved to various positions within outer track member 5′b with much reduced friction in doing so. FIG. 10 shows a top cross section view of compound linking structure 5′ with the upper sides of enclosure 5′c and partially enclosed track structure 5′d of outer track member 5′b removed to reveal the upper grooved edge of rack strip member 5′e in the rotary force assertion space and interior track space of outer track member 5′b, and with ball bearings 8 in the channel in the revealed grooved edge. FIG. 11 shows a side cross section view of enclosure 5′c with ball bearings 8 trapped between it and rack strip member 5′e in the channels in the upper and lower outer walls of this enclosure and the channels in the grooved edges of rack strip member 5′e.

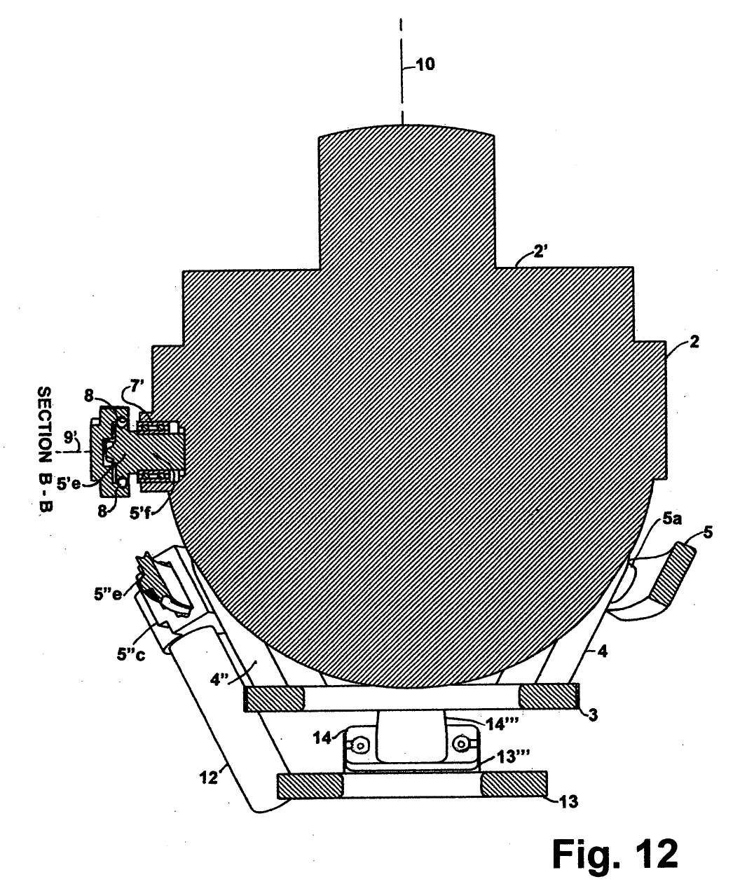

The rotatable connection between linking structure 5′ and output structure 2 in assembly is provided by pin 5′f extending through the slot in partially enclosed track structure 5′d of outer track member 5′b into the circular opening in the inner race of a bearing, 7′, with its collar against that race. Bearing 7′ has its outer race fixed in a circular hole in the side of output structure 2 (with this structure having an outward protruding extension collar there to effectively deepen that hole) as seen to at least some extent in FIGS. 1, 4 and 5. A more complete showing is provided in the side cross section view of manipulator 1 in FIG. 12 which corresponds to a section line, B-B, indicated in the top view of FIG. 4 which is rotated from section line A-A of that figure leading to the view in FIG. 12 being rotated approximately 90° along the vertical from the view shown thereof in FIG. 8.

Similarly, compound linking structure 5″ further has a rack strip member, 5″e, variably positionable in the rotary force assertion space and interior track space of outer track member 5″b. Rack strip member 5″e has an outer major surface on one side thereof and an inner major surface on the opposite side thereof along the length of that member with each major surface extending between two grooved edges on opposite sides of these major surfaces, and that are grooved by each edge having a recessed channel therein along the length of that member. The outer major surface of rack strip member 5″e has gear teeth symmetrically positioned between the grooved edges thereof along the length of that member, and the inner major surface is flat between the grooved edges along the member length except for having affixed thereat a circular pin, 5″f, with a collar at its fixedly supported root, extending toward output structure 2 through the slot in outer track member 5″b.

Additional ones of ball bearings 8 are trapped in assembly in the channels of the grooved edges of rack strip member 5″e by the interior sides of enclosure 5″c, and by partially enclosed track structure 5″d of outer track member 5″b with its enclosing ends. This enclosure and structure both also have channels therein across from those of the grooved edges to aid in trapping ball bearings 8. Ball bearings 8 are otherwise free to rotate in those channels to thereby enable rack strip member 5″e to be moved to various positions within outer track member 5″b with much reduced friction in doing so. The arrangement shown for linking structure 5′ in FIGS. 9, 10 and 11 is also followed for linking structure 5″.

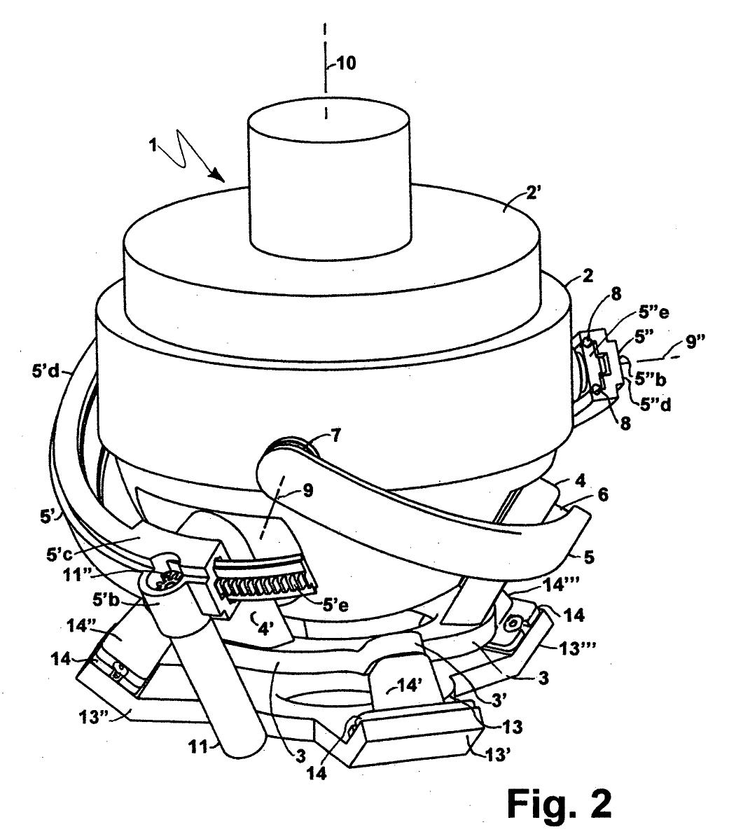

The rotatable connection between linking structure 5″ and output structure 2 in assembly is provided by pin 5″f extending through the slot in partially enclosed track structure 5″d of outer track member 5″b into the circular opening in the inner race of a bearing, 7″, with its collar against that race. Bearing 7″ has its outer race fixed in a circular hole in the side of output structure 2 (with this structure having an outward protruding extension collar there to effectively deepen that hole) as seen to at least some extent in FIGS. 2, 4 and 5. The axes of rotations of output structure 2 about circular pins 5f, 5′f and 5″f are indicated by dashed lines, 9, 9′ and 9″ in the figures where they are shown corresponding to those pins, these axes shown meeting at a common point. A dashed line output axis, 10, symmetrically positioned with respect to circular pins 5b, S′f and 5″f and rotation axes 9, 9′ and 9″, as well as being positioned symmetrically with respect to workpiece 2′, is also shown in the figures corresponding to those pins and axes to thereby result in axis 10 extending from the common intersection point of rotation axes 9, 9′ and 9″.

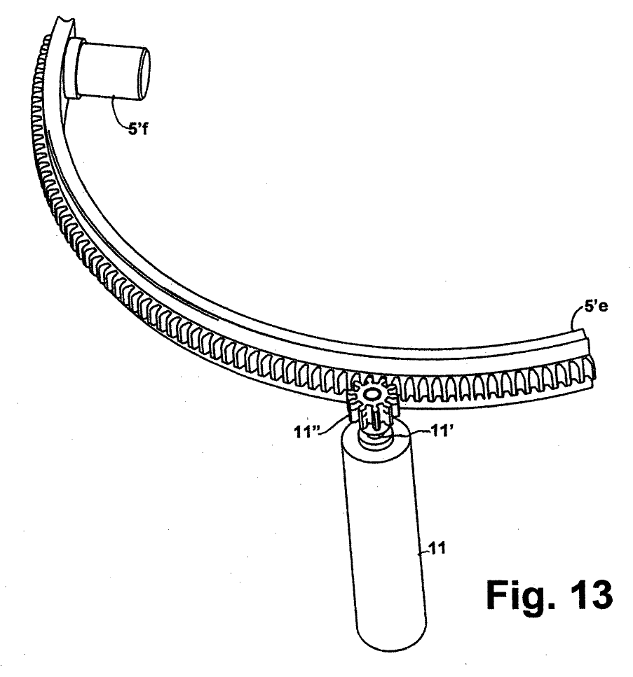

As seen in many of the figures, there is a pair of electric motors, 11 and 12, that can be used to cause compound linking structures 5′ and 5″, respectively, to undergo changes in their lengths, along the length variation paths followed thereby, under control of a rack strip member positioning control system (not shown) to thereby set varying orientations of axis 10. Thus, motor 11 is mounted in enclosure 5′c, and has an output shaft, 11′, extending therefrom to support and rotate a spur type pinion gear, 11″, that is engaged with the gear teeth at the outer major surface of rack strip member 5′e in the rotary force assertion space within enclosure 5′c of outer track member 5′b. Though, as indicated, this arrangement is seen in many of the figures, it is best seen in FIGS. 9, 10 and 11 and is further shown in the perspective view of FIG. 13.

Selectively rotating pinion gear 11′ with motor 11 allows variably positioning rack strip member 5′e in the rotary force assertion space and interior track space of outer track member 5′b through the resulting force applied on the gear teeth of rack strip member 5′e forcing that member to move with respect to outer track member 5′b. Either an increase or a decrease of the separation distance between circular pin 5′f and circular pin 5′a results depending on the direction of rotation selected for motor 11 to rotate pinion gear 11″. An increase in the separation distance results in linking structure 5′ pushing output structure 2 away from support standard 4′, and decreasing that distance results in linking structure 5′ pulling them toward one another, thereby, in either instance, changing the spatial orientation of output axis 10 through rotations of output structure 2 about some or all of axes 9, 9′ and 9″.

Similarly, motor 12, mounted in enclosure 5″c, has an output shaft, 12′, extending therefrom to support and rotate a spur type pinion gear, 12″. Gear 12″ is engaged with the gear teeth at the outer major surface of rack strip member 5″e in the rotary force assertion space within enclosure 5″c of outer track member 5″b. As indicated, this arrangement for motor 12 changing the length of linking structure 5″ is seen in many of the figures and follows the same arrangement used for motor 11 changing the length of linking structure 5′.

Thus, selectively rotating pinion gear 12″ with motor 12 allows variably positioning rack strip member 5″e in the rotary force assertion space and interior track space of outer track member 5″b through the resulting force applied on the gear teeth of rack strip member 5″e forcing that member to move with respect to outer track member 5″b. Again, either an increase or a decrease of the separation distance between circular pin 5″f and circular pin 5″a results depending on the direction of rotation selected for motor 12 to rotate pinion gear 12″. Here, similarly, increasing the separation distance results in linking structure 5″ pushing output structure 2 away from support standard 4″, and decreasing that distance results in linking structure 5″ pulling them toward one another, thereby, in either instance, changing the spatial orientation of axis output 10 through rotations of output structure 2 about some or all of axes 9, 9′ and 9.

These motions of the rack strip members with respect to the corresponding one of the outer track members more or less containing it can be coordinated through the selective operations of motors 11 and 12 to position output axis 10 as desired in a conical workspace. Fixed length linking structure 5 is correspondingly forced to move by the resulting movement of output structure 2 with respect to support standard 4. In doing so, linking structure 5 stabilizes the motion of output structure 2 by limiting the range of motions otherwise available to output structure 2 in being rotated by motors 11 and 12. If the user is willing to accept a reduced range of motion is orienting axis 10, one of motors 11 and 12 can be kept in a fixed position, or eliminated altogether by substituting a fixed length linking structure for the compound linking structure associated with that motor.

FIGS. 6 and 7 show two different positions of output axis 10 with, in FIG. 6, both of linking structures 5′ and 5″ being relatively extended to thereby provide relatively larger pins separation distances. These extensions force linking structure 5, as a result, to keep the location on output structure 2, to which it is rotatably connected, relatively close to base 3 and so thereby tilt that output structure relatively toward that connection location. In FIG. 7, in contrast, the pin separation distances in both of linking structures 5′ and 5″ are relatively short and so linking structure 5, as a result, forces the location on output structure 2, again, to which it is rotatably connected, to move upward relatively farther from base 3 to thereby tilt that output structure more toward a location halfway between the rotatable connections of linking structures 5′ and 5″ thereto. Increasing the length of the pin separation distance of one of linking structures 5′ and 5″, while decreasing the length of the other, will move output axis 10 to one side or the other of the plane that axis followed in responding alternatively to the generally symmetrical lengthening, and to the generally symmetrical shortening, of those linking structures described just above.

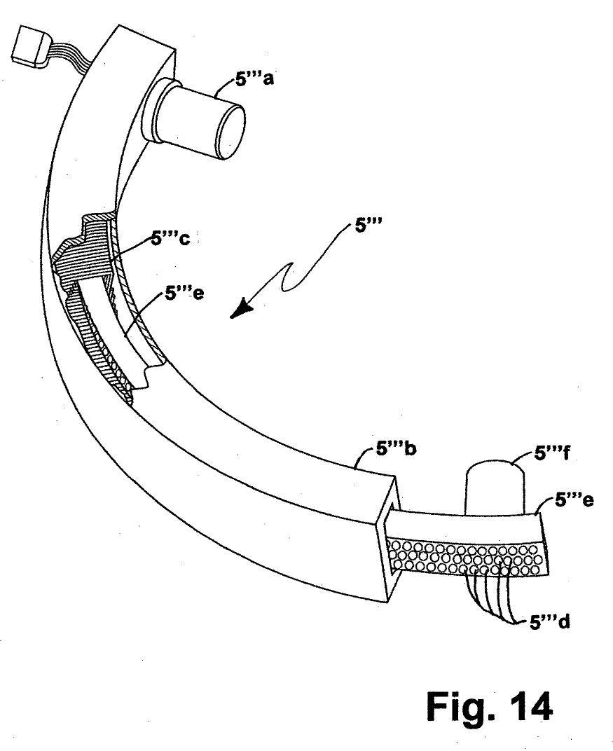

An alternative for compound linking structures 5′ and 5″, as well as for motors 11 and 12, is shown in FIG. 14 as linking sturcture, 5′″, in the form of a tubular linear motor that again extends along a spatial circular arc path as did linking structures 5′ and 5″. This motor also has a circular pin, 5′″a, with a collar at its fixedly supported root, extending toward output structure 2 from an outer tube track member, 5′″b, thereof with an electrical current coil, 5′″c, positioned around and along an interior passageway in that tube. Such positions can be effected either by being impregnated with a plastic material about that passageway to leave plastic material surfaces thereabout, or by being wrapped about a plastic inner tube providing within its walls such an interior passageway. This resulting plastic interior surface about the interior passageway provides a relatively small friction sliding surface along which permanent magnets, 5′″d, contained in a core strip, 5′″e, can together be relatively easily mechanically slid.

Such sliding is in response forces thereon resulting from electrical currents being established in the coil to provide magnetic fields interacting with permanent magnets 5′″d. Such sliding also changes the separation distance between circular pin 5′″a and another circular pin, 5′″f, with a collar at its fixedly supported root, that is affixed to the end of core strip 5′″e farthest from circular pin 5′″a. An increase or a decrease in this distance depends on the sufficiency and direction of electrical current correspondingly selectively provided in the coil from a controlled source thereof (not shown). Pin 5′″f extends toward the interior of the linking structure, and is variably positioned by core strip 5′″e in the interior passageway of outer tube track member 5′″b in response to coil currents. Typically, positioning sensors are also included therein for the operation of this linear motor by a core strip positioning control system (not shown). Other kinds of force generating structures could also be used in forming variable length linking structures instead, or in addition to, the compound linking structures and motors already described such as piezoelectric motor arrangements or shaped memory alloy actuator arrangements.

Interior base 3, although formed primarily as a circular ring, has, as indicated above, lugs 3′, 3″ and 3′″, to which an exterior base, 13, is fastened which again has a primary ring with a center opening. Exterior base 13 is the actual base that is affixed to an appropriate mount in the device in which manipulator 1 is to be used. Exterior base 13 also has three lugs, 13′, 13″ and 13′″, symmetrically spaced about the periphery of the primary ring of base 13, with each being formed by a corresponding extension from the outer edge of the base primary ring partially in the plane of that ring but, separated by a distance from the ring edge, to thereby be inclined upward from the in-plane portion at an angle of approximately 30° with respect to the ring plane. These inclined lug ends each form a plane mounting surface for that lug inclined to the ring plane. This plane mounting surface for each of lugs 13′, 13″ and 13′″ has a plate, 14, fastened thereto from which a corresponding one of resilient, typically elastomeric, material pad shock mounts, 14,′ 14″ and 14′″, extends outward perpendicular to that plate toward a corresponding one of lugs 3′, 3″ and 3′″ of interior base 3. A corresponding fastener, 15, extends through the center opening of each of lugs 3′, 3″ and 3′″ into the corresponding one of elastomeric shock mounts 14,′ 14″ and 14′″ to thereby fasten bases 3 and 13 to one another with these shock mounts positioned between them.

Although the present invention has been described with reference to preferred embodiments, workers skilled in the art will recognize that changes may be made in form and detail without departing from the spirit and scope of the invention.

1. A controlled relative motion system permitting a controlled motion member, joined to a base member, to selectively move with respect to said base member, said system comprising:
a base support,
an output structure,
a plurality of securing links each rotatably connected at one end thereof to said base support and rotatably connected at an opposite end thereof to said output structure, including a fixed length securing link that is rotatably connected at one end thereof to said base support and rotatably connected at an opposite end thereof to said output structure, and further including a variable length securing link that is rotatably connected at one end thereof to said base support and rotatably connected at an opposite end thereof to said output structure and that also has a force distributor therewith that can be directed to vary a separation distance between said ends thereof, and
a force imparting member coupled to said variable length securing link force distributor capable of directing said force distributor to vary said separation distance between said variable length securing link ends.

2. The apparatus of claim 1 wherein each of said plurality of securing links extends along a corresponding circular arc axis.

3. The apparatus of claim 1 wherein said variable length securing link has an inner member that is at least partially surrounded by an outer member and that is moveable with respect thereto, said outer member having a rotation connection end that is also one of said variable length securing link ends and said inner member having a rotation connection end that is also that remaining one of said variable length securing link ends.

4. The apparatus of claim 3 wherein said inner member has a series of gear teeth along a length thereof, said force distributor is a gear that is engaged with said gear teeth, and said force imparting member is a rotation motor having an output shaft coupled to said gear.

5. The apparatus of claim 3 wherein said inner member has permanent magnets therein, said force distributor is a coil positioned about said inner member, and said force imparting member is a controlled source of electrical current.

6. The apparatus of claim 3 wherein each of said plurality of securing links extends along a corresponding circular arc axis including said inner and outer members of said variable length securing link extending along said circular arc axis thereof.

7. The apparatus of claim 1 wherein said plurality of securing links consists of three securing links each rotatably connected at one end thereof to said base support with substantially equal angular spacing therebetween, and also each rotatably connected at an opposite end thereof to said output structure with substantially equal angular spacing therebetween.

8. The apparatus of claim 7 wherein said plurality of securing links includes said fixed length securing link, said variable length securing link as a first variable length securing link, and a second variable length securing link that is rotatably connected at one end thereof to said base support and rotatably connected at an opposite end thereof to said output structure and that has a force distributor therewith that can be directed to vary a separation distance between said ends thereof, said force imparting member is a first force imparting member, a second force imparting member coupled to said second variable length securing link force distributor capable of directing said force distributor to vary said separation distance between said second variable length securing link ends.

9. The apparatus of claim 8 wherein each of said plurality of securing links extends along a corresponding circular arc axis.

10. The apparatus of claim 8 wherein each said first and second variable length securing links has an inner member that is at least partially surrounded by an outer member and that is moveable with respect thereto, said outer member of a corresponding said variable length securing link having a rotation connection end that is also one said end of said corresponding said variable length securing link and said inner member of that corresponding said variable length securing link having a rotation connection end that is also that remaining said end of that said corresponding variable length securing link.

11. The apparatus of claim 10 wherein each said inner member of a corresponding said variable length securing link has a series of gear teeth along a length thereof, each corresponding said force distributor is a gear that is engaged with said gear teeth in said corresponding inner member, and each corresponding said force imparting member is a rotation motor having an output shaft coupled to said corresponding gear.

12. The apparatus of claim 10 wherein said inner member of a corresponding said variable length securing link has permanent magnets therein, each corresponding said force distributor is a coil positioned about said corresponding inner member, and each corresponding said force imparting member is a controlled source of electrical current.

13. The apparatus of claim 10 wherein each of said plurality of securing links extends along a corresponding circular arc axis including said inner and outer members of each said corresponding variable length securing link extending along said circular arc axis thereof.

14. The apparatus of claim 1 wherein said base support has a plurality of attachment lugs therein, and further comprising a mounting structure having a plurality of mounting lugs therein, said attachment lugs each being connected to a corresponding one of said mounting lugs with a resilient pad therebetween.
